(19) United States
(12) Patent Application Publication
(10) Pub. No.: US 2023/0172277 A1
(43) Pub. Date: Jun. 8, 2023

(54) ELECTRONIC AEROSOL PROVISION SYSTEM

(71) Applicant: Nicoventures Trading Limited, London (GB)

(72) Inventor: Laziz TURAKULOV, London (GB)

(21) Appl. No.: 17/906,737

(22) PCT Filed: Feb. 25, 2021
(86) PCT No.: PCT/GB2021/050479

§ 371 Date: Sep. 19, 2022

(30) Foreign Application Priority Data
Mar. 19, 2020 (GB) 2003961.6

(51) Int. Cl. A24F 40/51; A24F 40/65; A24F 40/60; A24F 40/42; A24F 40/53

(52) U.S. Cl. CPC A24F 40/51; A24F 40/65; A24F 40/60; A24F 40/42; A24F 40/53; A24F 40/10

(57) ABSTRACT

An electronic aerosol provision system, said system including a motion sensor, at least one computing device, and an artificial intelligence (AI) model configured to run on the at least one computing device, the model defining an alphabet of multiple characters, each character corresponding to a movement pattern; wherein the AI model is further configured to receive data from the motion sensor representing spatial motion of the electronic aerosol provision system, and based on the received data, to discriminate a particular character from the alphabet of multiple characters as user input to the electronic aerosol provision system when the spatial motion of the electronic aerosol provision system matches the movement pattern of the particular character.

### PRIORITY CLAIM

The present application is a National Phase entry of PCT Application No. PCT/GB2021/050479, filed Feb. 25, 2021, which claims priority from Great Britain Application No. 2003961.6, filed Mar. 19, 2020, each of which is hereby fully incorporated herein by reference.

### TECHNICAL FIELD

The present disclosure relates to an electronic aerosol provision system.

### BACKGROUND

Electronic aerosol provision systems (devices), including e-cigarettes, electronic vapor provision devices and systems, electronic aerosol/vapor/nicotine delivery devices and systems, and the like, may have a modular form. For example, such a device (system) may comprise a cartridge containing an aerosol precursor material, such as a reservoir of liquid, and a control unit containing a power source, such as a battery. When a user operates the device, such as by pressing a button or inhaling on a mouthpiece of the device, the control unit operates the battery to provide power to generate an aerosol from the aerosol precursor material. In many devices, the cartridge includes an atomizer, such as a resistive heater that generates the aerosol by vaporizing a small amount of liquid (such a cartridge may be referred to as a cartomizer).

Accordingly, electronic aerosol provision systems typically incorporate two consumables, firstly a liquid or other aerosol precursor material, and secondly power in the battery. Regarding the former, once a reservoir of liquid or other aerosol precursor material has been exhausted, the cartridge may be refilled, or alternatively discarded to allow replacement with a new cartridge. Regarding the latter, an e-cigarette usually includes some form of wired or wireless (inductive) facility to receive power from an external charging facility, thereby allowing the battery to be re-charged.

Electronic aerosol provision systems are sometimes provided with more sophisticated functionality. For example, some systems may provide a user control interface to alter the level, duration and/or time profile of heating power supplied by the battery. Such alteration may help to personalize the system for a particular user (or for a particular mood of the user). Another example of a user control operation is to enter a PIN (personal identification number), which may be required to enable use of the device.

However, while it is desirable for an electronic aerosol provision system to have a user interface that supports such increasingly complex functionality, it also remains desirable to provide an electronic aerosol provision system which is compact, readily portable, robust, low in power consumption, and not too expensive. It can be difficult for the developer of an electronic aerosol provision system to reconcile these various design objectives.

### SUMMARY

The disclosure is defined in the appended claims.

An electronic aerosol provision system is provided herein. The system includes a motion sensor, at least one computing device, and an artificial intelligence (AI) model configured to run on the at least one computing device. The model defines an alphabet of multiple characters, each character corresponding to a movement pattern. The AI model is further configured to receive data from the motion sensor representing spatial motion of the electronic aerosol provision system, and based on the received data, to discriminate a particular character from the alphabet of multiple characters as user input to the electronic aerosol provision system when the spatial motion of the electronic aerosol provision system matches the movement pattern of the particular character.

Also provided herein is a device for use as the control unit of an electronic aerosol provision system. The device includes a motion sensor, at least one computing device, and an artificial intelligence (AI) model configured to run on the at least one computing device. The model defines an alphabet of multiple characters, each character corresponding to a movement pattern. The AI model is further configured to receive data from the motion sensor representing spatial motion of the control unit, and based on the received data, to discriminate a particular character from the alphabet of multiple characters as user input to the control unit when the spatial motion of the control unit matches the movement pattern of the particular character.

### BRIEF DESCRIPTION OF THE DRAWINGS

Various implementations of the disclosure will now be described in detail by way of example only with reference to the following drawings:

FIG. 1 is a high-level schematic (exploded) diagram of an electronic aerosol provision system (device).

FIG. 2 is a high-level schematic diagram of a control unit of the electronic aerosol provision system of FIG. 1.

FIG. 3 is a high-level schematic diagram of a cartomizer (cartridge) of the electronic aerosol provision system of FIG. 1.

FIG. 4 is a high-level schematic diagram of certain electrical components of the control unit of FIG. 2, including an artificial intelligence (AI) model.

FIG. 5 is a high-level schematic diagram showing an example of using the AI model in the electronic aerosol provision system of FIG. 1 to recognize and output recognized characters.

FIG. 6 is a schematic flowchart showing in more detail an example of the operation of the AI model in the electronic aerosol provision system of FIG. 1 to recognize and output recognized characters.

FIGS. 7 and 8 are examples of characters which may be recognized using the AI model in the electronic aerosol provision system of FIG. 1.

FIG. 9 is a schematic flowchart showing the process of training and deploying the AI model to the electronic aerosol provision system of FIG. 1.

### DETAILED DESCRIPTION OF THE DRAWINGS

The present disclosure relates to an electronic aerosol provision system (device). As used herein, the term “electronic aerosol provision system” refers to an aerosol provision system comprising one or more electronic components, such as a controller for controlling operations of the electronic aerosol provision system. The electronic aerosol provision system may or may not comprise its own power source (such as a battery). The controller may be configured to control any suitable operation of the aerosol provision device, including, but not limited to, delivery of at least one substance to a user. The generation of an aerosol from an aerosol-generating material may or may not be achieved through electronic means.

In some implementations, the electronic aerosol provision system is a “non-combustible” aerosol provision system. According to the present disclosure, a “non-combustible” aerosol provision system is one where a constituent aerosol-generating material of the aerosol provision system (or component thereof) is not combusted or burned in order to facilitate delivery of the at least one substance to the user.

In some implementations, the non-combustible aerosol provision system is an electronic cigarette (e-cigarette), also known as a vaping device or electronic nicotine delivery system (END), although it is noted that the presence of nicotine in the aerosol-generating material is not a requirement.

In some implementations, the non-combustible aerosol provision system is an aerosol-generating material heating system, also known as a heat-not-burn system. An example of such a system is a tobacco heating system.

In some implementations, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some implementations, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some implementations, consumables comprising or consisting of aerosol-generating material are configured to be used with non-combustible aerosol provision devices. These consumables are sometimes referred to as articles throughout the disclosure.

In some implementations, the non-combustible aerosol provision system may comprise an exothermic power source. In some implementations, the exothermic power source comprises a carbon substrate which may be energized so as to distribute power in the form of heat to an aerosol-generating material or to a heat transfer material in proximity to the exothermic power source.

In some implementations, the non-combustible aerosol provision system may comprise an area for receiving the consumable, an aerosol generator, an aerosol generation area, a housing, a mouthpiece, a filter and/or an aerosol-modifying agent.

In some implementations, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some implementations, the electronic aerosol provision system may comprise a combustible aerosol provision system. According to the present disclosure, a “combustible” aerosol provision system is one where a constituent aerosol-generating material of the aerosol provision system (or component thereof) is combusted or burned during use in order to facilitate delivery of at least one substance to a user.

As used herein, aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some implementations, the aerosol-generating material may comprise an “amorphous solid”, which may alternatively be referred to as a “monolithic solid” (i.e. non-fibrous). In some implementations, the amorphous solid may be a dried gel. The amorphous solid is a solid material that may retain some fluid, such as liquid, within it. In some implementations, the aerosol-generating material may, for example, comprise from about 50 wt %, 60 wt % or 70 wt % of amorphous solid, to about 90 wt %, 95 wt % or 100 wt % of amorphous solid.

As appropriate, the aerosol-generating material may comprise one or more active constituents, one or more flavors, one or more aerosol-former materials, and/or one or more other functional materials. The active substance as used herein may be a physiologically active material, which is a material intended to achieve or enhance a physiological response. The active substance may, for example, be selected from nutraceuticals, nootropics, and psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In some implementations, the active substance comprises nicotine. As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof. The aerosol-former material may comprise one or more constituents capable of forming an aerosol, for example glycerin or glycol. The one or more other functional materials may comprise one or more of pH regulators, coloring agents, preservatives, binders, fillers, stabilizers, and/or antioxidants.

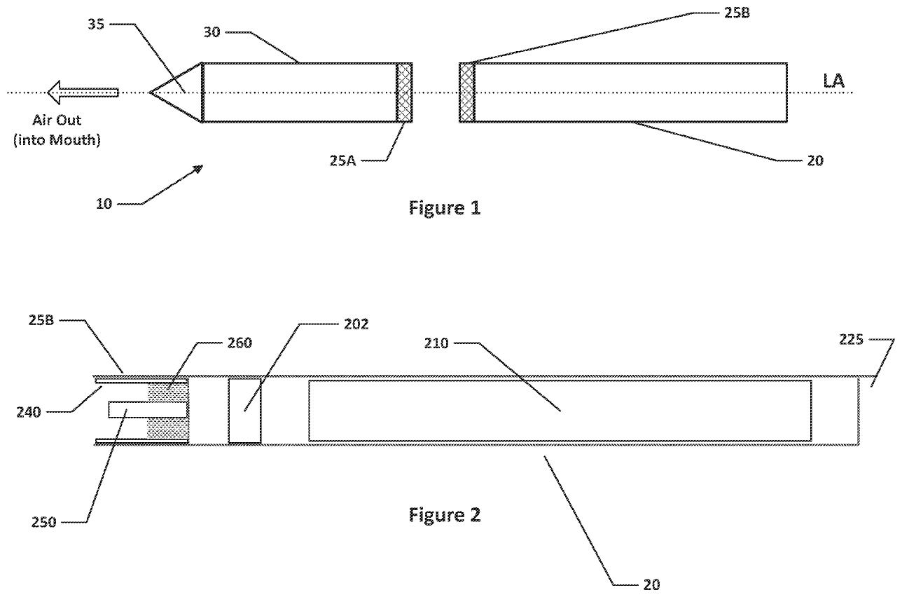

FIG. 1 is a schematic (exploded) diagram of an example of an electronic aerosol provision system. The system has a generally cylindrical shape, extending along a longitudinal axis indicated by dashed line LA, and comprises two main components, namely a control unit (body) 20, which is sometimes referred to herein as an aerosol provision device (or, more simply, device), and which is generally a reusable component, and a cartomizer (cartridge) 30, which typically represents a consumable component. The aerosol provision device 20 and consumable 30 together form the aerosol provision system 10. The system 10 is generally compact for easy portability (e.g. in a pocket or bag) and for handheld use.

The cartomizer 30 includes an aerosol-generating material storage area, which in this example is an internal chamber containing a reservoir of liquid (where the liquid is an example of an aerosol-generating material), an aerosol generator (sometimes referred to as a vaporizer), which in the following example is a heater, and a mouthpiece 35. However, in accordance with the above, it should be appreciated that different aerosol-generating materials other than liquid may be used.

In some implementations, liquid in the reservoir typically includes nicotine in an appropriate solvent, and may include further constituents, for example to aid aerosol formation and/or for additional flavoring as discussed above. The reservoir may include a foam matrix or any other structure for retaining the liquid until it is delivered to the vaporizer, alternatively, the liquid may be held free in the reservoir. The cartomizer 30 may further include a wick or similar facility to transport a small amount of liquid from the reservoir to a heating location adjacent the heater (more generally, the wick is an example of an aerosol-generating material transfer component).

The control unit 20 normally includes at least one re-chargeable cell or battery to provide power to system 10 and at least one circuit (e.g. provided as a printed circuit board (PCB) or a flexible circuit) for generally controlling the system. When the heater receives power from the battery, as controlled by the circuit board, the heater vaporizes the liquid from the wick and this vapor is then inhaled by a user through the mouthpiece 35. This use of an electronic aerosol provision system in which a user inhales an electrically generated vapor through a mouthpiece is typically referred to as vaping.

The control unit 20 and cartomizer 30 are detachable from one another by separating in a direction parallel to the longitudinal axis (LA) of the aerosol provision system 10, as shown in FIG. 1, but are joined together for use by a connection indicated schematically in FIG. 1 as 25A and 25B, which may be implemented as a bayonet or screw fitting or any other suitable form of coupling. As such, the control unit 20 may be said to comprise an area or region for receiving the consumable. This connection 25A, 25B provides mechanical and electrical connectivity between the control unit 20 and the cartomizer 30. The control unit 20 may also be provided with a facility (not shown) for connecting the control unit to an external power supply. For example, this facility may comprise a (micro/mini/type C) USB port.

The system 10 may be provided with one or more external holes (not shown in FIG. 1) for air inlet. These holes may be located in the control unit 20 and connect to an air passage through the control unit 20, through the connector 25A, 25B, before linking to an air path through the cartomizer 30 to the mouthpiece 35. When a user inhales on the mouthpiece 35, air is drawn into the control unit 20, and this airflow (or the resulting change in pressure) may be detected by a pressure sensor. In response to this detection, the system 10 may activate the heater to vaporize the liquid received (via the wick) from the reservoir. The airflow through the vaporizer combines with the resulting vapor, and this combination of airflow and vapor passes out of the cartomizer 30 through the mouthpiece 35 to be inhaled by a user. The cartomizer 30 may be detached from the body 20 and disposed of when the supply of liquid is exhausted and replaced with another cartomizer 30 if so desired. In some implementations, the cartomizer 30 may alternatively (or additionally) be refillable. The liquid therefore represents an aerosol-generating material for use with device 20.

FIG. 2 is a schematic (simplified) diagram of the control unit 20 of the electronic aerosol provision system of FIG. 1, and can generally be regarded as a cross-section in a plane containing the longitudinal axis LA. As shown in FIG. 2, the control unit 20 includes a battery 210 and a printed circuit board 202 on which is mounted at least one chip, such as an application specific integrated circuit (ASIC) or microcontroller, for controlling the system 10. The PCB 202 may be positioned alongside or at one end of the battery 210. In the configuration shown in FIG. 2, the PCB is located between the battery 210 and the connector 25B. The control unit 20 may also include an airflow and/or pressure sensor (not shown) which is used (inter alia) to detect an inhalation on mouthpiece 35. In response to such a detection of inhalation, the sensor notifies the chip on the PCB 202, which in turn initiates the flow of power from the battery 210 to a heater in the cartomizer 30. The control unit 20 may include one or more air inlet holes (not shown) to allow air to enter the control unit 20 and flow past the sensor when a user inhales on the mouthpiece 35, thereby enabling the sensor to detect the user inhalation.

The distal end of the control device 20 (i.e. the end opposite the mouthpiece 35 when the system 10 is in use) is denoted as the tip end 225, while at the opposite end of the control unit 20 (i.e. the proximal end closest to the user in use) is the connector 25B for joining the control unit 20 to the cartomizer 30. As noted above, the connector 25B provides mechanical and electrical connectivity between the control unit 20 and the cartomizer 30. As shown in FIG. 2, the connector 25B may include a body (control unit) connector 240, which may be metallic (or metal-coated) to serve as a first (outer) terminal for electrical connection (positive or negative) to the cartomizer 30. The connector 25B further includes an electrical contact 250 to provide a second (inner) terminal for electrical connection to the cartomizer 30 of opposite polarity to the first terminal. The body connector 240 generally has an annular or tubular shape which is aligned with the longitudinal access (LA) of the control unit 20 (and the overall system 10). The electrical contact 250 may be in the form of a pin located in the center of the body connector 240, i.e. the contact 250 is aligned and coincident with the longitudinal axis LA. The body connector 240 and the electrical contact 250 are separated by an insulator 260, which is also annular in shape.

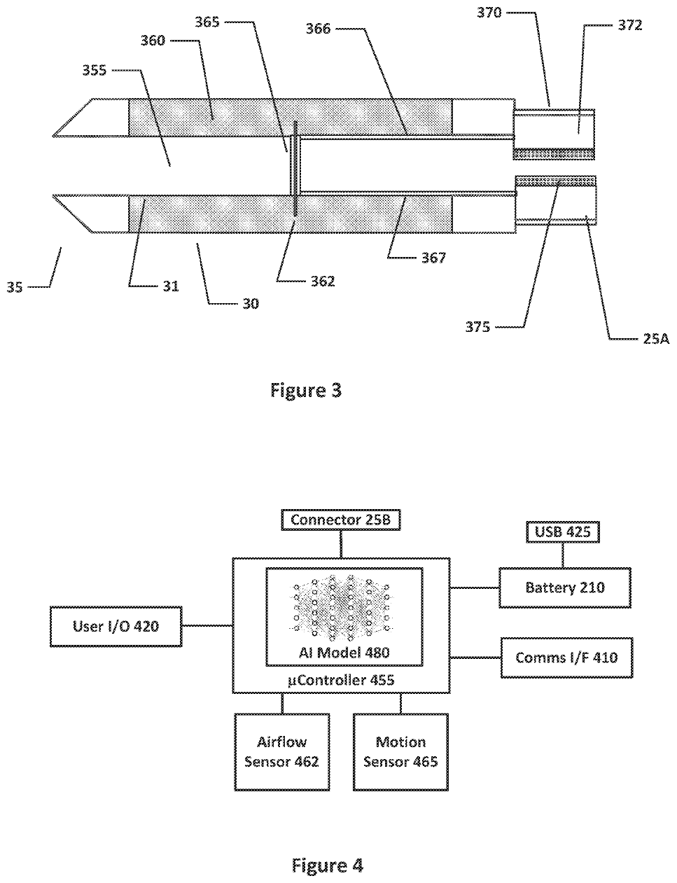

FIG. 3 is a schematic diagram of the cartomizer 30 of the system 10 of FIG. 1, and again can generally be regarded as a cross-section in a plane which includes the longitudinal axis LA. The cartomizer 30 includes an inner tube 31 which provides and encloses an air passage 355 extending along the central (longitudinal) axis of the cartomizer 30 from the mouthpiece 35 to the connector 25A for joining the cartomizer 30 to the control unit 20. A reservoir of liquid 360 (typically including nicotine in a solvent) is provided around the air passage 355. For example, the reservoir 360 may be formed between the tube that defines the air passage 355 and the outer housing of the cartomizer 30. The reservoir 360 may comprise cotton or foam soaked in the liquid, or the liquid may be held freely in the reservoir 360 (i.e. without any such cotton or foam or other holding matrix). The liquid acts as an aerosol precursor material, as described in more detail below.

The cartomizer 30 further includes a mechanical and electrical connector 25A to couple to the mechanical and electrical connector 25B of the control unit 20. The connector 25A has a complementary shape and structure to the connector 25B and comprises an inner electrode 375 and an outer electrode 370 that are separated by an insulator 372, all of which have an annular shape parallel to and aligned with the longitudinal axis LA. The electrical connector 25A is configured to engage and couple to the electrical connector 25B. In particular, when the cartomizer 30 is connected to the control unit 20, the inner electrode 375 contacts the electrical contact 250 of the control unit 20 to provide a first electrical path between the cartomizer 30 and the control unit 20, while the outer connector 370 contacts the body connector 240 of the control unit 20 to provide a second electrical path between the cartomizer 30 and the control unit 20. The inner electrode 375 and the outer electrode 370 therefore serve as positive and negative terminals (or vice versa) for receiving power by the cartomizer 30 from the battery 210 in the control unit 20.

The cartomizer 30 further includes a wick 362 and a heater 365. The wick 362, which may be made of any suitable porous material, such as cotton, glass fiber, ceramic, etc., extends from the reservoir 360 across and through the air passage 355. Likewise, the heater 365 may be implemented in any suitable manner, for example, as a resistive heater in the form of a wire coil or metal mesh, a ceramic plate or disk, and so on. The heater 365 is electrically connected to terminals 370 and 375 via supply lines 366 and 367 to receive power from the control unit 20 (and the battery therein). The wick 362 is located close to the heater 365, e.g. the heater 365 may surround or be surrounded by the wick, so that liquid transported by the wick 362 from reservoir 360 is heated by the heater 365 to generate vapor that flows along the air passage 355 and out of the mouthpiece 35 in response to a user inhaling on the electronic aerosol provision system 10.

Note that various components and details have been omitted from FIGS. 2 and 3 for reasons of clarity. For example, detailed wiring is generally not shown, such as between the connector 25B, the circuit board 202, and the battery 210, and likewise for the wiring between the power lines 366, 367 and the contact 25A. Similarly, input/output facilities (such as buttons or LEDs) for the system 10 are not shown.

It will also be appreciated that the configuration of the electronic aerosol provision system 10 shown in FIGS. 1-3 is by way of example only to provide an illustrative context for the present application. The skilled person will be aware of many potential variations, for example, rather than being a two-part system (control unit 20 and cartomizer/cartridge 30), the system 10 may be formed as a one-piece device, or alternatively may be formed from three or more sections. The aerosol-generating material may comprise a solid rather than a liquid, potentially in leaf or powdered form (or a gel or paste, etc.) as described above. In some implementations, the system 10 may initially generate a stream of heated vapor (e.g. steam) that passes through and therefore heats the aerosol-generating material to generate the aerosol. In some implementations, the system 10 may comprise multiple different aerosol-generating materials and support making combinations or selections of such materials. Some devices may include a removable cartridge containing the reservoir 360, but the atomizer (such as heater 365) may not be included in this cartridge (e.g. the atomizer may be in a separate component). In addition, rather than having the control unit 20 extend distally from the cartomizer 30 to provide a linear airflow along the longitudinal axis LA, other implementations might have a folded arrangement. Moreover, the heater 365 may be implemented in various forms, for example, as a planar mesh or as a ceramic heater. In some cases, the atomizer may be provided as some form of nebulizer, e.g. based on vibration rather than heating. A person skilled in the art will appreciate that these examples are just a small subset of the possible variations in configuration for the electronic aerosol provision system 10 as disclosed herein.

FIG. 4 is a schematic diagram of certain electrical (including electronic) components of the control unit of FIG. 1. Note that at least some of these components are shown by way of example only and may be omitted (and/or supplemented or replaced by other components) according to the circumstances of any given implementation. Furthermore, although the components shown in FIG. 4 are assumed to be located in the control unit 20 rather than in the cartomizer 30 (since a given control unit may be re-used with many different cartomizers 30), other configurations may be adopted as desired. In addition, the components shown in FIG. 4 may be located on one circuit board 202, but other configurations may be adopted as desired, e.g. components may be distributed across multiple circuit boards, or may not (all) be mounted on circuit boards. Furthermore, for clarity FIG. 4 omits various elements which are commonly present in this type of device, such as most power lines, memory (RAM) and/or (non-volatile) storage (ROM) and so on.

FIG. 4 includes a (re-chargeable) battery 210 and a connector 25B for coupling to a cartomizer (cartridge) 30, as discussed above, and a (micro)controller 455, as discussed below. The battery 210 is further linked to a USB connector 425, e.g. a micro or mini or type C connector, which can be used to re-charge the battery 210 from an external power supply (typically via some re-charging circuit, not shown in FIG. 4). Note that other forms of re-charging may be supported for battery 210—for example, by charging through some other form of connector, by wireless charging (e.g. induction), by charging through connector 25B, and/or by removing the battery 210 from the e-cigarette 10.

The device of FIG. 4 further includes a communications interface 410 which can be used for wired and/or wireless communications with one or more external systems (not shown in FIG. 4), such as a smartphone, laptop and/or other form of computer and/or other appliance. The wireless communications may be performed using (for example) Bluetooth and/or any other suitable wireless communications standard. It will be appreciated that USB interface 425 may also be used to provide a wired communications link instead of (or in addition to) the communications interface 410; for example, the USB interface 425 might be used to provide the system with wired communications while the communications interface 410 might be used to provide the system with wireless communications.

Communications to and/or from the electronic aerosol provision system 10 may be used for a wide variety of purposes, such as to collect and report (upload) operational data from the system 10, e.g. regarding usage levels, settings, any error conditions, and/or to download updated control programs, configuration data, and so on. Such communications may also be used to support interaction between the electronic aerosol provision system 10 and an external system such as a smartphone belonging to the user of the electronic aerosol provision system 10. This interaction may support a wide variety of applications (apps), including collaborative or social media-based apps.

The device of FIG. 4 further includes a motion sensor 465 (as discussed below), and an airflow sensor 462 to detect when a user has inhaled on the system 10. Such a detection may trigger a supply of power by a microcontroller 455 from the battery 210 to the cartomizer 30 (in particular to heater 365) to produce a vapor output for inhalation by the user (this process is generally referred to as puff-activation). The sensor 462 may detect airflow via any suitable mechanism, such as by monitoring for a flow of air and/or a change in pressure. Note that some systems 10 do not support puff actuation; these systems are typically activated by a user pressing on a button (or some other form of direct input). The microcontroller 455 may specify (and implement) one or more heating profiles for use with the heater 365; such a profile determines the variation with time in the level of power that is supplied to heater 365. For example, the microcontroller 455 may supply most power to the heater 365 from the battery 210 at the start of a puff in order to rapidly warm the heater 365 to its operating temperature, after which the microcontroller 455 may supply a reduced level of power to the heater 365 sufficient to maintain this operating temperature.

The device of FIG. 4 may further include user I/O functionality 420 to support direct user input into the system 10 (this user input/output may be provided instead of, or more commonly in addition to, the communications functionality discussed above). The user output may be provided as one or more of visual, audio, and/or haptic output (feedback). For example, visual output may be implemented by one or more light emitting diodes (LEDs) or any other form of lighting, and/or by a screen or other display—such as a liquid crystal display (LCD), which can provide more complex forms of output. The user input may be provided by any suitable facility, for example, by providing one or more buttons or switches on the system 10 and/or a touch screen (which supports both user input and output). As described below, user input may also be performed by movement of the device 20 (or of the whole system 10), such movement being detected using the motion sensor 465. In this case, the motion sensor 465 can be considered as part of the user input/output facility 420.

The microcontroller 455 may be located on PCB 202, which may also be used for mounting other components as appropriate, e.g. the motion sensor 465 and/or the communications interface 410. Some components may be separately mounted, such as the airflow sensor 462, which may be located adjacent the airflow path through the system 10, and a user input facility (e.g. buttons) which may be located on the external housing of the system 10. The microcontroller 455 generally includes a processor (or other processing facility) and memory (ROM and/or RAM). The operations of the microcontroller 455 (and some other electronic components), are typically controlled at least in part by software programs running on the processor in the controller (or other electronic components as appropriate). Such software programs may be stored in a non-volatile memory which can be integrated into the microcontroller 455 itself, or provided as a separate component (e.g. on PCB 202). The processor may access ROM or any other appropriate store to load individual software programs for execution as and when required. The microcontroller 455 also contains suitable interfaces (and control software) for interacting with the other components of system 10 (such as shown in FIG. 4). In addition, the microcontroller 455 supports an artificial intelligence (AI) system (model) 480, shown schematically in FIG. 4 as an interconnected network of nodes, e.g. a neural network, and described in more detail below.

The configuration shown in FIG. 4 may be varied as appropriate by a person of ordinary skill in the art. For example, the functionality of the (micro)controller 455 may be distributed across one or more components which act in combination as the microcontroller 455. In addition, there may be a PCB or similar provided in combination with a battery 210 to control re-charging of the battery 210, such as to detect and prevent voltage or current overload and/or overly long charging times, and likewise to control discharging of the battery 210, e.g. so that the battery 210 does not get excessively discharged to the point of damage. It will be appreciated that the above set of alternatives and variations on the configurations of FIGS. 1-4 is by no means exhaustive, and many further alternatives and variations will be apparent to a person skilled in the art.

In some implementations, the motion sensor 465 is provided by a module LSM6DSLTR which is commercially available from STMicroelectronics and is used as a combined accelerometer and gyroscope (in effect, a 2-in-1 system-in-package chip). In particular, this device provides a 3D digital gyroscope and a 3D digital accelerometer—i.e. 3-axis sensitivity for both rotational and linear motion respectively. Further details of this module are available at: https://www.st.com/content/st_com/en/products/mems-and-sensors/inemo-inertial-modules/lsm6dsl.html.

Note that the power consumption of the LSM6DSLTR device is of the order of 0.5 mA for an “always on” configuration. Assuming a typical capacity of 500 mA hours for the battery 210, the power consumption of the motion sensor 465 per day represents 2.4% of the batterycapacity. This level of power consumption for motion sensor 465 can be readily supported, given that e-cigarettes are often re-charged on a daily basis (the vaporization of the liquid generally requires a relatively high current level).

In some implementations, the microcontroller 455 is provided by a STM32F429ZIT6 module which is commercially available from STMicroelectronics and incorporates an ARM Cortex-M4 core with a digital signal processor, floating point unit and flash memory. The module includes timers for pulse width modulation (PWM), which is typically used in e-cigarettes to vary the output from the heater 365, for example, in line with heating profile as mentioned above. In particular, the duty cycle of the PWM may be decreased to supply a reduced amount of power to the heater 365, or raised to increase the power level. Further details are available at:

https://www.st.com/content/st_com/en/products/microcontrollers-microproces sors/stm32-32-bit-arm-cortex-mcus/stm32-high-performance-mcus/stm32f4-series/stm32f429-439/stm32f429zi.html.

In some implementations, the AI model 480 is provided using the TensorFlow Lite platform, originally developed by Google, and subsequently released as an open-source deep learning framework for on-device inference, see https://www.tensorflow.org/lite. Alternative platforms that might be used for the AI model 480 include PyTorch, which was originally developed by Facebook and subsequently released as an open source machine learning library, see https://pytorch.org/, and/or the Microsoft Cognitive Toolkit (CNTK), which is an open source toolkit for distributed deep learning, see https://docs.microsoft.com/en-us/cognitive-toolkit/. The AI model 480 is installed on the microcontroller 455, which in effect acts as a computing device in the electronic vapor provision system for running the AI model 480.

As described herein, the motion sensor 465 and the AI model 480 are used in combination to provide a user input mechanism for the electronic vapor provision system 10. In particular, the artificial intelligence (AI) model 480 is configured to run on the microcontroller 455 or other computing device. The AI model 480 defines a set (alphabet) of multiple characters, each character corresponding to a movement pattern. The AI model 480 is further configured to receive data from the motion sensor 465 representing spatial motion of the electronic aerosol provision system. Based on the received data, the AI model 480 discriminates (identifies or determines) a particular character from the alphabet of multiple characters as user input to the electronic aerosol provision system 10 when the spatial motion of the electronic aerosol provision system 10 matches the movement pattern of the particular character.

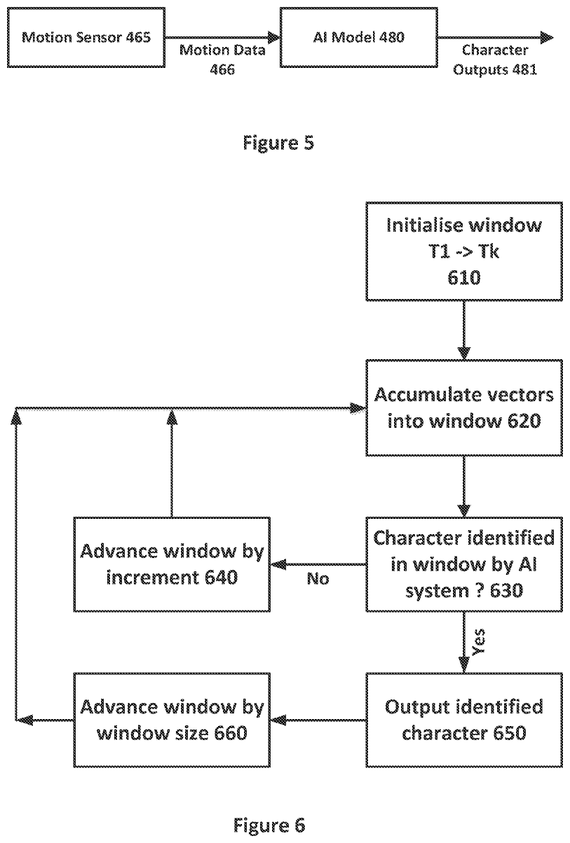

This processing is illustrated in FIG. 5, which shows the motion sensor 465 producing a time series of motion data 466 which is passed to the AI model 480. Based on this input, the AI model 480 then determines one or more output characters 481. The AI model 480 therefore acts as a classifier, in that a given input of motion data 466 is considered to represent or denote a particular character from the available alphabet of the AI model 480, and this particular character is then output by the AI model 480 as the selected output character 481 that corresponds to the input motion data 466. The motion data 466 may represent a user input sequence of one or more characters, and the output from the AI model 480 should then comprise a corresponding sequence of one or more respective output characters.

The particular nature and format of the motion data 466 passed from the motion sensor 465 to the AI model 480 will depend on the particular implementation and situation. For example, using the LSM6DSLTR device mentioned above, the motion data 466 can be expressed as a time sequence of vectors, V(t1), V(t2), etc., each vector comprising six values V(t1) [\ddot{x}, ÿ, \ddot{z}, Δ∅1, Δ∅2, Δ∅3], in which the first three values represent linear acceleration at time t1 for the x, y and z axes respectively, and the second three values represent the change in angle or orientation of the device at time t1, e.g. about the x, y, and z axes respectively. The LSM6DSLTR device can therefore be regarded as a six-axis product.

The sampling rate for the motion data 466 is sufficient to provide an accurate indication of the motion of the device (sufficiently accurate to discriminate reliably between the different characters in the alphabet). For example, using the LSM6DSLTR device mentioned above, a sampling rate in the range 100-1000 Hz has typically been employed, i.e. a time increment or interval (t2−t1) between successive samples in the range 0.001 s˜0.01 s.

The motion sensor 465 may provide the motion data 466 to the AI model 480 in the form of individual vectors as they are captured (sensed), or may accumulate multiple successive vectors into blocks or matrices for transmission to the AI model 480. In the latter case, the motion sensor 465 then transmits the motion data 466 as a series of blocks or matrices to the AI model 480. Note that the number of vectors accumulated into an individual block prior to transmission should be limited in order to provide good responsiveness and avoid latency—e.g. the accumulated vectors in a given block might represent no more than ≈0.5 s (for example). Typically motion sensor 465 provides the motion data 466 to the AI model 480 as blocks having a constant (fixed) number of vectors.

It will be appreciated that other implementations may provide motion data 466 which has a different content, format, timing and/or other properties compared to those discussed above. For example, the values for linear acceleration might be replaced (or supplemented) by position coordinates defined with respect to the x, y and z axes to give a succession of [x, y, z] values. In some cases, the motion data 466 might only comprise the linear positions or accelerations (but without the angular measurements). Indeed, if the user action with the device is analogous to writing on the wall, it might be feasible to provide only two spatial coordinates for the motion data 466, in effect representing a position on the surface of the (imagined) wall, and dropping the spatial coordinate extending perpendicular to the imagined surface of the wall (this would then represent a two-axis device).

Conversely, some known motion sensors are presented as 9-axis devices—see, for example, the 9-Axis MotionTracking products from InvenSense (https://www.invensense.com/products/motion-tracking/9-axis/). These devices combine a 3-axis gyroscope, a 3-axis accelerometer, and a 3-axis compass on a single chip. Compared with a 6-axis device described above, a 9-axis device is able to provide absolute values for orientations in space (rather than just measuring movement, such as rotations from one orientation to another).

In some implementations, the motion sensor 465 is able to discriminate between periods of motion and periods of no motion—the latter being determined if values such as those specified for V(t1) above have little or no variation. The motion sensor 465 may respond to a detection of a period of no motion by stopping the transmission of motion data 466 from the motion sensor 465 to the AI model 480 (until new motion is again detected from the sensed values). In some implementations, this detection that motion has ceased may be performed, for example, by an input filter on the AI model 480, rather than within the motion sensor 465 itself.

Many other possible variations relating to the generation and handling of motion data 466 will be apparent to a person of ordinary skill in the art. Nevertheless, in most implementations, the motion sensor 465 is expected to be an off-the-shelf component, such as the LSM6DSLTR device mentioned above, in which case the motion data 466 is likely to be fairly standardized and comprehensive in nature. Moreover, in general, increasing the quality and quantity of the data, such as by having more axes of data, better spatial and/or temporal resolution, etc., will help to support quicker and more reliable character classification for larger sets of symbols.

FIG. 6 is a schematic flowchart showing in more detail an example of the recognition process of FIG. 5. The processing is performed in conjunction with the AI model 480, and initially a time window is defined from T1->Tk, i.e. the k successive samples from t=1, t=2 . . . through to t=k (operation 610). Each sample represents a vector of motion values received from the motion sensor 465, thereby accumulating a time sequence of vectors, V(t1), V(t2), such as described above into the window (operation 620). Again, the value of k is selected based on the trade-off (for example) between good recognition accuracy and low latency.

When the samples fill the window, the motion data 466 is analyzed by the AI model 480 to see if a character is present for identification (operation 630). If so, the identified character 481 is output (operation 650), and the window is then advanced or flushed (operation 660) to look for the next character in a new window period; e.g. the new window period might be T(k+1)->T2k in order to acquire the next set of samples. The AI model 480 then loops back to operation 620 and accumulate vectors of the motion sensor data 466 in this new window period. If no character is identified at operation 630, the window may be advanced at operation 640 by a smaller increment, for example, so as to extend from

T6->T(k+5) (where k>5). In effect, this slides the window along by a portion of the window duration (rather than by the full window duration as at operation 660). The AI model then loops back (iterate) to operation 620 as before. The incremental approach of operation 640 is useful in (approximately) aligning the start of the window with the start of a character encoded in the time sequence of motion data 466, which can help symbol recognition and classification.

It will be appreciated that the processing of FIG. 6 represents one example of suitable processing, but many variations will be apparent to the skilled person. For example, FIG. 6 utilizes a fixed window size (=Tk−T1), however, some implementations may also search for characters using a range of different window sizes. In this way, the AI model 480 is able to look for characters with different start times and/or different durations in the motion data 466. Note that such searching for characters may utilize some form of parallel processing, e.g. multi-threading, to help look across the parameter space of different window durations and different window start times.

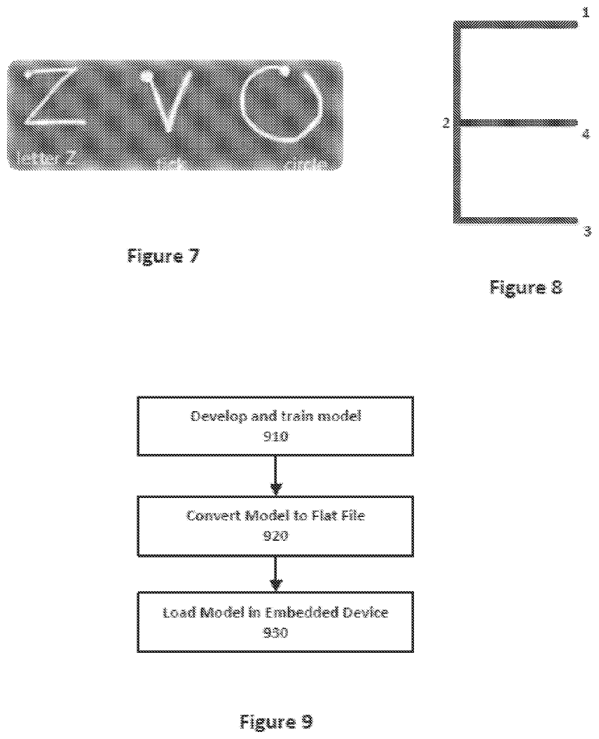

FIG. 7 shows three examples of characters (symbols) that may be present in the alphabet supported by the AI model 480, namely a Z, a tick, and a circle. Each character starts at the location indicated by the small circle, which is generally located towards the top and left of the symbol, and the symbol then continues in an unbroken line to the endpoint. The characters or symbols supported by the AI model 480 may be alpha-numerical characters (i.e. letters and/or numerals), or other symbols or shapes which may be reasonably indicated or drawn using the device 20 (such as the tick of FIG. 7).

By way of illustration, the “tick” symbol might be used to activate the device 20. For example, if the device 20 has gone into a sleep mode (low-power), such a symbol might cause the device 20 to wake up, and/or such a symbol might act as a user command to initiate the supply of power to the heater 365 for the device if it is not puff-actuated. The “circle” symbol of FIG. 7 might be used (for example) to lock the device 20, and/or to send it into sleep mode.

Although all the characters in FIG. 7 have a progressive (monotonic) motion from start to finish, this may not be possible for all characters. For example, FIG. 8 shows an example of a symbol (“E”) for which some back-tracking is needed (it is not possible to draw an E with a continuous line otherwise). As illustrated in FIG. 8, this E could be created by starting at location 1, moving to location 2 and then on to location 3, before returning to location 2 to then finish at location 4 to complete the E. It will be understood that the AI model 480 is generally trained to recognize not the visual appearance of the final symbol (such as the “E”), but rather the movement of the e-cigarette in representing this symbol. For example, the location sequence 1-2-3-2-4 (as set out above) and the location sequence 1-2-4-2-3 would both produce an “E” in terms of conventional writing, but would generally be seen as different characters by the AI model 480. Accordingly, if the AI model 480 were to be trained on the location sequence 1-2-3-2-4 for the symbol E, the location sequence 1-2-4-2-3 would not be recognized as representing this symbol. However, this situation could be accommodated if so desired by specifically training the AI model 480 to recognize multiple different sequences as representing a single (i.e. the same) output character. Note that similar considerations apply to discontinuous symbols, such as an “i”, where the device 20 is moved from the body of the “i” to the dot at the top to create the symbol.

The characters or symbols for input into the system are typically of an intermediate size. This avoids overly large symbols, which may be relatively cumbersome for a user to enter (and may not be practical in confined or crowded spaces, or when the user is sitting down); it also avoids overly small symbols, which may be more difficult for a user to follow accurately, or may be more prone to accidental implementation. In this context, an intermediate size for the symbols might typically be in the range 5-60 cm, 10-40 cm, or about 15-25 cm. (The size could be considered as corresponding to the diameter of the smallest circle that could contain the symbol, or any other suitable measure).

It will be appreciated that an electronic aerosol provision system 10 may undergo movement, for example, when being carried in a pocket or bag. Such movement is not intended to cause a character input to the system 10. In practice, the AI model 480 has been found to be reasonably robust against misinterpreting such movement as a character input, but further protection if desired against such misinterpretation can be achieved by a variety of techniques, for example:
A Machine Learning system (i.e. AI model 480) typically indicates how confident it is that the input movement (gesture) corresponds to a particular symbol or character—e.g. a given gesture might correspond to a symbol for unlock at 75% confidence, or to a symbol for power up at 20% confidence, or to a symbol for power down at 5%. The system might normally choose the output symbol as the symbol having the greatest confidence level (i.e. unlock in the above example). However, the system might be set so that a given (threshold) confidence level (say 80%) is needed to make an identification of the output and to initiate any corresponding action. Accordingly, the output of the AI model and resulting system operation will have a greater confidence and so be more robust in rejecting movements that accidentally somewhat resemble a particular gesture. (The higher threshold may require a user to “draw” his/her gestures more precisely).
A “wake up” might be required from a user before any subsequent symbol gesture is entered. Such a “wake-up” might be implemented by a relative quick gesture, such as a quick left-right or up-down movement, which is then follow by the actual “command” gesture. This combination of 2 gestures together for any input can help to reduce the risk of unintentional movement being misinterpreted as a symbol gesture.
The device might accept gestures only if another sensor is also awake, e.g. an infrared sensor, in order to confirm that the device itself is in somebody's hand and not in the pocket or bag.

The above protection measures may be applied (if needed) individually or in combination with one another. Moreover, it will be appreciated that further protection measures may be employed as required.

FIG. 9 is a high-level flowchart showing the development of a compact machine learning model which is trained and then deployed to recognize the user input of particular characters (gestures) as described herein. Adopting the TensorFlow Lite platform cited above (by way of example), the AI model 480 may first be developed and trained as per operation 910 on an external computing system (such as a laptop, desktop, server, etc).

In particular, operation 910 may include first defining a set (alphabet, catalogue or vocabulary) of characters/symbols/gestures to be recognized. As noted above, the characters may be alphanumeric, existing or newly created symbols, and so on. The hardware and software platforms identified above have been found to support an alphabet of 20-60 different characters, and it is envisaged that more powerful hardware and software may support a larger alphabet.

After the AI model 480 has been successfully trained on a given set of characters, at operation 920, the AI model 480 can then be converted (such as by using the TensorFlow Lite Converter program) into a compressed flat buffer (e.g., a .tflite file). This compressed file is then ready for loading (deployment) into microcontroller 455 as an embedded device at operation 930 to serve as a user input mechanism as described herein.

In general, the AI model 480 runs on the electronic vapor provision system 10 itself to perform the recognition/classification of input characters. However, it is also possible that the electronic vapor provision system 10 might interact with some external device such as a smartphone or laptop (for example, using communications interface 410) to offload some or all of the processing associated with the AI model 480 onto the external device (in which case the output characters 481 might be returned to the user via the external device, such as by using a laptop screen).

Note that the characters being entered into the device 10 for recognition with AI model 480 are symbolic in nature. In other words, movement of the device by a user is not being used to provide a direct analogue of some physical parameter such as position, speed, etc (as might be used, for example, in the context of gaming). Rather, the user input is used to perform a selection (classification) from a discrete (finite) set of distinct possibilities, each possibility being associated with a respective symbol. The AI model is trained to match particular examples of motion data 466 produced by user input (movement of the device) to corresponding particular characters of a desired alphabet. It will be appreciated that the training phase 910 may be iterative in nature. For example, if the AI model 480 is having trouble discriminating between two different characters, the alphabet might be revised to modify or remove one of the troublesome characters (or potentially to replace the removed character by another, more distinctive, character).

More generally, the system 10 may have various levels of configurability. For example, in some implementations, the AI model 480 may be finalized (fixed) without the ability to be changed. In this case, a user may be provided with the set (alphabet) of characters to use, such as in a hard-copy instruction manual. In some cases, the user may be able to supplement the existing AI model by providing additional training data for different symbols to be recognized. In some cases, the user may be able to change (re-train) the model for existing characters by altering the pattern for a given character (this may involve replacing rather than supplementing the original training data). For example, a user may retrain the AI model 480 in this manner to recognize a “g” when inputting a “g”. A further possibility is that the user may be able to change (re-train) the model to support additional (i.e. new) characters in the alphabet (as well as, or possibly instead of, changing the model for existing characters). For example, the user may be able to add a newly created character to the existing alphabet, or in some cases, create an entirely new alphabet (which may be personalized to the user).

Depending upon the capabilities of the system 10, such changes to the AI model 480 may be performed on an external system, such as a smartphone or laptop, e.g. using communications interface 410. In such cases, the external system may acquire the existing AI model 480 (whether from electronic aerosol provision system 10, or from some other appropriate source), update the model 480, and then convert the model 480 back to a flat file and reload the model into the electronic aerosol provision system 10, as per operations 920 and 930 of FIG. 9. Note that software may be provided or made available by the supplier of the electronic aerosol provision system 10 to facilitate and guide the user through such updating of the AI model 480.

In some systems 10, the AI-based input mechanism may interact with or be supported by other elements of a user interface to support operation of the AI model 480. For example, the system may be configured to prompt the user for a character input (such prompt might possibly be used just for the first character in a string of characters, or possibly for each character in the string). Similarly, the system may be configured to notify the user when a character input has been successfully identified (again, possibly just for the first character in a string of characters or possibly for each character). This prompting and/or confirmation may take various forms, such as audible output (e.g. a beep or suchlike), haptic feedback using vibration of the system 10, and/or visual output such as provided by an LED lamp.

Additionally (or alternatively), a system 10 may allow a user to indicate the start and/or end of a character input (again, possibly just for the first character in a string of characters or possibly for each character). Such indication might be provided, for example, by pressing a button on the system 10, or by tapping the system 10.

It will be appreciated that prompting/confirming user input, or a user indicating the start/end of such input, may facilitate the AI model 480 recognizing an input character (such as by helping with determining the start of a recognition window as per FIG. 6). Likewise, feedback from the device 20 to a user may be helpful for confirming that the user input has been recognized as intended.

The use of motion sensor 465 and AI model 480 to provide and recognize user input may be utilized in many different ways for system 10. The following examples are provided by way of illustration, without limitation—any given device may support none, one, some or all of these examples.

For some systems, the user input recognized by the AI model 480 may comprise a pass code or password, analogous to a personal identification number (PIN), to enable (authorize) operation of the device 20 (and/or complete system 10). For example, the pass code might comprise a sequence of multiple (e.g. four or six) symbols for recognition by the AI model 480; if this pass code is not entered, some functionality of the device 20 or overall system 10 might be locked or restricted, for example, the heater 365 might not be activated to prevent vaping. For some systems, the user input recognized by the AI model 480 may be used to set one or more operating parameters for the system 10. In some cases this may involve entering both an identifier and a value for the operating parameter of interest. For example, the system 10 may support multiple heating levels during vaping, and the AI model 480 may be utilized to set a desired heating level, such as low, medium or high. Other examples of user input to an AI model 480 may be to reset error conditions, to select a desired heating profile, to navigate menu structures, to control and perform data communications with an external device, such as a smartphone, and so on.

For a modular system 10, the AI input functionality is typically (although not necessarily) provided in the body or control unit (device) 20. Nevertheless, there may still be an interaction with a cartridge 30 (e.g. a cartomizer), for example, the AI input may be used to obtain user inputs for controlling a cartridge connected to a control unit. In some systems, the control unit 20 may be responsive to the connection of a cartridge (and/or to the identity of such a cartridge) for adapting the user input that can be recognized by the AI model 480. For example, an AI input to change a power level to the heater 365 might only be available if the cartridge 30 attached to the control unit 20 supports having a user-configurable power level; otherwise such input might not be recognized (or might be recognized but not acted upon). Thus in some cases, the alphabet or vocabulary supported by the AI input facility may be adjusted based on whether and/or which cartridge is attached to the device. More generally, the system 10 might change the active set of symbols (i.e. those that are available for recognition) according to the status of the system 10—e.g. whether or not a cartridge is connected, which type of cartridge is connected, whether the battery needs recharging, and so on.

It will be appreciated that a user input mechanism which utilizes a motion-based AI model 480 as described herein has a number of benefits compared with conventional user input mechanisms for the electronic vapor provision system 10. For example, it is relatively common for the electronic vapor provision system 10 to be provided with one or more physical buttons (switches) for various purposes, such as to turn the system off and on, to increase or reduce heating power, and so on. These buttons may be implemented as mechanical, movable inputs, and/or as tactile inputs on a touch screen. However, such buttons must generally be physically accessible via the outer (external) housing of the electronic vapor provision system. This typically complicates the design and reduces the overall integrity of the external housing in order to accommodate such a button, as well as adding to the cost and complexity of the assembly process for the electronic vapor provision system 10. Furthermore, the input from a single button is relatively limited and inflexible—e.g. just a single binary state (yes/no) might be indicated. In addition, the cost of incorporating motion sensor 465, providing (for example) 3D gyroscope and accelerometer sensors, into the electronic vapor provision system 10 is generally significantly lower than the cost of accommodating a touch screen display (for example) into the electronic vapor provision system 10. A further consideration is that the size of electronic components such as motion sensor 465 may be significantly smaller than the size of a physical button (since the latter must maintain a large enough cross-section to allow user operation by hand).

Another approach is for a user to have an external device, such as a smartphone, to serve as an input device for the electronic vapor provision system 10, with data then being transmitted from the external device into the electronic vapor provision system 10 (and vice versa) over a wired and/or wireless communications facility. Although this approach has increased scope and flexibility for data input, it relies upon a user having a suitable external device readily available—which might not always be the case. In contrast, the use of AI model 480 as a user input mechanism does not rely on any external equipment.

A further approach for user input is to incorporate just an accelerometer into the electronic aerosol provision system 10 to detect certain simple actions being performed by a user—e.g. tapping the electronic vapor provision system 10 against a solid surface. However, this type of approach is again relatively limited and inflexible in terms of the type and range of data input that might be realized compared with the use of AI model 480 for a user input mechanism as described herein.

It will also be appreciated that use of the motion sensor 465 and the AI model 480 as a user input may serve to complement (rather than necessarily replace) existing user input facilities. As an example of this, a mechanical on/off button might be provided which physically opens or closes a circuit link (having a physical break in a circuit for the off state may provide slightly greater protection, for example, against accidental activation of the system).

The AI model 480 described herein may be implemented on any suitable AI platform including a wide range of statistical and computing structures, such as neural networks, support-vector machines, Bayesian classifiers, machine learning systems, and so on. The AI model 480 is generally implemented on the aerosol provision device 10 itself, potentially with support from an external device, such as a smartphone or tablet computer, for example, for installing and/or updating the model.

More generally, the electronic vapor provision system 10 as disclosed herein incorporates a spatial correlation between movement of the electronic vapor provision system 10 and user input of a symbol to the system. The electronic vapor provision system 10 may include a classifier that uses this correlation to map from the detected movement of the electronic vapor provision system 10 to a corresponding symbol which the user is inputting into the system.

The AI-supported user input facility described herein can be implemented in a wide range of devices, including a combustible aerosol provision system, a non-combustible aerosol provision system or an aerosol-free delivery system.

As described herein, embedding 3D gyroscope and accelerometer sensors into the electronic aerosol provision system 10 or device, e.g. onto a circuit board of such a device, is generally less costly and complex than adding a touchscreen. A compact machine learning model may then be trained and deployed to recognize consumer gestures (based on the motion data from the 3D gyroscope and accelerometer sensors) to complement or even fully replace mechanical operations. Certain actions may be pre-built into the model: e.g., “tick” to activate a device, “circle” to lock it, and so on. In some implementations, consumers may be able to train custom gestures into the model, for example by using a companion app, e.g. to specify an “unlock” combination. Running machine learning models to recognize consumer gestures made with the system or device can (inter alia) help differentiate the system as a “smart” product; potentially reduce cost and/or size of the system by replacing one or more mechanical parts with cheaper and smaller electronic sensors; and/or help to integrate the system into a consumer's smart home network and daily life activities.

Also described herein is the electronic aerosol provision system 10 (or device forming part therefore), which includes a nine-axis motion sensor, which is able to provide absolute values for orientations in space. For example, the nine-axis motion sensor may combine a 3-axis gyroscope, a 3-axis accelerometer, and a 3-axis compass, and these may be located together on a single chip. The output from the nine-axis motion sensor may be used as input to the AI model 480 as described herein, or for any other appropriate purpose.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the disclosure as defined by the claims or limitations on equivalents to the claims, and that other embodiments may be utilized and modifications may be made without departing from the scope of the claimed invention. Various embodiments of the disclosure may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An electronic aerosol provision system, said system including a motion sensor, at least one computing device, and an artificial intelligence (AI) model configured to run on the at least one computing device, the model defining an alphabet of multiple characters, each character corresponding to a movement pattern;
wherein the AI model is further configured to receive data from the motion sensor representing spatial motion of the electronic aerosol provision system, and based on the received data, to discriminate a particular character from the alphabet of multiple characters as user input to the electronic aerosol provision system when the spatial motion of the electronic aerosol provision system matches the movement pattern of the particular character.

2. The electronic aerosol provision system of claim 1, wherein the motion sensor is configured to output 3-axis linear motion or acceleration data.

3. The electronic aerosol provision system of claim 1, wherein the motion sensor is configured to output 3-axis angular motion or acceleration data.

4. The electronic aerosol provision system of claim 1, wherein the motion sensor is configured to output 3-axis absolute spatial orientation data.

5. The electronic aerosol provision system of claim 1, wherein the motion sensor is configured to collect samples of motion data at a rate of at least 10 Hz, for example at least 20 Hz, at least 40 Hz, at least 65 Hz, or at least 100 Hz.

6. The electronic aerosol provision system of claim 5, wherein the motion sensor is configured to collect samples of motion data at an interval in the range 0.001˜0.01 seconds.

7. The electronic aerosol provision system of claim 1, wherein the motion sensor is configured to assemble multiple samples of motion data occurring during a time window, and for each time window, to send together to the AI model the multiple samples of motion data occurring during that time window.

8. The electronic aerosol provision system of claim 1, wherein the AI model is provided as a flat buffer file.

9. The electronic aerosol provision system of claim 1, wherein said alphabet contains 5 or more characters, 10 or more characters, 20 or more characters, 40 or more characters.

10. The electronic aerosol provision system of claim 1, wherein said alphabet contains between 20 and 60 characters.

11. The electronic aerosol provision system of claim 1, wherein said characters represent abstract, symbolic user input for the electronic aerosol provision system.

12. The electronic aerosol provision system of claim 1, wherein said characters are used to input one or more of the following operations: waking up the electronic aerosol provision system for a low power mode; sending the electronic aerosol provision system into a low power mode; setting a power level for the electronic aerosol provision system; setting a heater profile for the electronic aerosol provision system; and initiating power to the heater for use of the electronic aerosol provision system.

13. The electronic aerosol provision system of claim 1, wherein said characters are used to lock and/or unlock the electronic aerosol provision system, wherein the electronic aerosol provision system must be unlocked to produce vapor.

14. The electronic aerosol provision system of claim 1, wherein the AI model is configured to determine a string of one or more characters from the motion sensor data.

15. The electronic aerosol provision system of claim 1, wherein the AI model runs on the at least one computing device to discriminate characters from the motion sensor data.

16. The electronic aerosol provision system of claim 1, wherein the AI model offloads at least some of the processing onto an external system to discriminate characters from the motion sensor data.

17. The electronic aerosol provision system of claim 1, wherein one or more characters in the alphabet may be enabled or disabled for discrimination by the AI model based on the type of cartridge currently included in the electronic aerosol provision system.

18. The electronic aerosol provision system of claim 1, wherein the AI model includes a facility to change the alphabet by removing or amending existing and/or by adding new characters.

19. The electronic aerosol provision system of claim 1, wherein changing the alphabet is performed by interacting with an external system.

20. A method of operating an electronic aerosol provision system, said system including a motion sensor, at least one computing device, and an artificial intelligence (AI) model configured to run on the at least one computing device, the model defining an alphabet of multiple characters, each character corresponding to a movement pattern; the method comprising:
receiving, by the AI model, data from the motion sensor representing spatial motion of the electronic aerosol provision system; and
based on the received data, discriminating a particular character from the alphabet of multiple characters as user input to the electronic aerosol provision system when the spatial motion of the electronic aerosol provision system matches the movement pattern of the particular character.

21. A device for use as the control unit of an electronic aerosol provision system, said device including a motion sensor, at least one computing device, and an artificial intelligence (AI) model configured to run on the at least one computing device, the model defining an alphabet of multiple characters, each character corresponding to a movement pattern;
wherein the AI model is further configured to receive data from the motion sensor representing spatial motion of the control unit, and based on the received data, to discriminate a particular character from the alphabet of multiple characters as user input to the control unit when the spatial motion of the control unit matches the movement pattern of the particular character.

22. The electronic aerosol provision system including a cartridge and the device of claim 21.
